(19) United States
(12) Patent Application Publication
(10) Pub. No.: US 2016/0142897 A1
(43) Pub. Date: May 19, 2016

(54) Enriched D2D Discovery Content

(71) Applicant: TELEFONAKTIEBOLAGET L M ERICSSON (PUBL), Stockholm (SE)

(72) Inventors: Stefano Sorrentino, SOLNA (SE); Yufei Blankenship, KILDEER, IL (US)

(21) Appl. No.: 14/541,387

(22) Filed: Nov. 14, 2014

(51) Int. Cl. H04W 8/00; H04W 16/14; H04W 76/02

(52) U.S. Cl. CPC H04W 8/005; H04W 76/023; H04W 16/14; H04W 88/04

(57) ABSTRACT

The present disclosure relates to methods and devices for transmission of discovery messages for device-to-device, D2D, communication. More particularly the disclosure pertains to enriching D2D discovery messages to include information related to properties of the transmitting device. According to one aspect, the disclosure proposes a method performed in a wireless terminal 10, the wireless terminal 10 being configured for device-to-device, D2D, communication in a wireless communication system, the method comprising assembling S1 a discovery message 40 enabling D2D discovery, wherein the discovery message 40 comprises radio protocol stack control information 42 related to one or more properties of the transmitting wireless terminal 10 and broadcasting S2 the discovery message 40. The disclosure further relates to methods of receiving and using the discovery message.

### TECHNICAL FIELD

The present disclosure relates to methods and devices for transmission of discovery messages for device-to-device, D2D, communication.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink, and is thought of as a next generation mobile communication system relative to UMTS. In order to support high data rates, LTE allows for a system bandwidth of 20 MHz, or up to 100 Hz when carrier aggregation is employed. LTE is also able to operate in different frequency bands and can operate in at least Frequency Division Duplex, FDD and Time Division Duplex, TDD, modes.

Device-to-device communication is a well-known and widely used component of many existing wireless technologies, including ad hoc and cellular networks. Recently, device-to-device, D2D, communications as an underlay to cellular networks have been proposed as a means to take advantage of the proximity of communicating devices and at the same time to allow devices to operate in a controlled interference environment. Typically, it is suggested that such device-to-device communication shares the same spectrum as the cellular system, for example by reserving some of the cellular uplink resources for device-to-device purposes. Allocating dedicated spectrum for device-to-device purposes is a less likely alternative as spectrum is a scarce resource and dynamic sharing between the device-to-device services and cellular services is more flexible and provides higher spectrum efficiency.

D2D should also be able to operate in multi-carrier scenarios where cellular and/or D2D is configured to operate on multiple carriers. Such carriers do not necessarily belong to a single Operator and are not necessarily coordinated and synchronized. D2D applications include direct discovery and direct communication. In both cases, the transmitter sends D2D signals that should be directly received at least by the intended receivers. Additional applications include relaying, where a device relays data received from a network infrastructure or a device to another device, or vice-versa.

D2D opens up for further possibilities in the communication system. For example, surrounding D2D terminals may be used as reference devices for improved positioning of a target device. In such a situation additional signaling of control information may be needed. For example it may be necessary to signal device properties between the reference devices and the target device.

There are also other scenarios where it may be useful for a wireless terminal in a communication system to have knowledge about device properties of other devices in the communication system. For example the radio transmissions may be optimized if different radio properties are known or M2M devices may benefit from control information defining the M2M properties of other D2D devices in vicinity of the device.

### SUMMARY

An object of the present disclosure is to provide a way to distribute control information among D2D devices with small implementation, energy and overhead impact.

This object is obtained by a method performed in a wireless terminal, the wireless terminal being configured for device-to-device, D2D, communication in a wireless communication system. The method comprises assembling a discovery message enabling D2D discovery, wherein the discovery message comprises radio protocol stack control information related to one or more properties of the wireless terminal. The method further comprises broadcasting the discovery message. According to some aspects, the discovery message comprises payload data from a layer higher than that of the control information. Hence, by extending the discovery message, which was previously only used for discovery purposes, to additionally comprise lower layer control information describing the properties of the transmitting device, it is possible to improve operations in many different areas. For example the control information comprises information that can be used to optimize spectrum use or to calculate a position of a wireless terminal.

According to some aspects, the positioning related control information is either information defining a position of the wireless terminal or information that can be used to derive a position of the wireless terminal is spectrum related. Hence, using such information improved positioning may be provided.

According to some aspects, the control information is related to an estimated usage of the spectrum. By using such information D2D communication may be improved.

According to some aspects, the disclosure relates to a receiving wireless terminal being configured for device-to-device, D2D, communication in a communication system. The method comprises receiving, from a transmitting wireless terminal, a discovery message enabling D2D discovery, wherein the discovery message comprises radio protocol stack control information related to one or more properties of the transmitting wireless terminal ; and forwarding data related to the properties of the transmitting wireless terminal to another device in the wireless communication system and/or using the data related to the properties of the transmitting wireless terminal when communicating with one or more other devices in the wireless communication system.

According to some aspects, the forwarding comprises delivering the discovery message to a layer higher than that of the control information, in the receiving wireless terminal. Effects may be seen in the lower layers e.g. for transmission efficiency. However, the information may also be utilized in higher layers.

According to some aspects, the discovery message comprises payload data from a layer higher than that of the control information.

According to some aspects, the method further comprises calculating a position of the receiving wireless terminal based on the control information contained in the received discovery message. Then, the forwarding comprises forwarding data related to the calculated position of the receiving wireless terminal.

According to some aspects, the method further comprises performing measurements of at least one radio signal transmitted by the transmitting wireless terminal, and calculating a position of the receiving wireless terminal based on the control information contained in the received discovery message. Then, the forwarding comprises forwarding data related to the calculated position of the receiving wireless terminal.

According to some aspects, the method further comprises determining, based on the control information contained in the received discovery message, that the transmitting wireless terminal is capable of relaying data to a destination and requesting the transmitting wireless terminal to relay data from the receiving wireless terminal to the destination.

According to some aspects, the method further comprises selecting resources for D2D communication in the frequency domain, based on the control information contained in the received discovery message.

According to some aspects, the disclosure relates to a transmitting wireless terminal being configured for device-to-device, D2D, communication in a communication system. The transmitting wireless terminal is adapted to assemble a discovery message enabling D2D discovery. The discovery message comprises radio protocol stack control information related to one or more properties of the transmitting wireless terminal. The transmitting wireless terminal is further adapted to broadcast the discovery message.

According to some aspects, the disclosure relates to a receiving wireless terminal being configured for device-to-device, D2D, communication in a communication system, the receiving wireless terminal is configured to cause the receiving wireless terminal to receive, from a transmitting wireless terminal, a discovery message enabling D2D discovery, wherein the discovery message comprises Radio protocol stack control information related to one or more properties of the transmitting wireless terminal; and to forward, using the radio circuitry, data related to the properties of the transmitting wireless terminal to the communication system.

According to some aspects, the wireless terminal is a user equipment. According to some aspects, the wireless terminal is a relay node.

According to some aspects, the disclosure relates to computer program comprising computer program code which, when executed in a wireless terminal, causes the wireless terminal to execute the methods described above and below.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a and 1b schematically illustrate a mobile communication network including wireless terminals capable of device-to-device communication.

FIG. 2a illustrates the LTE OSI layers.

FIG. 2b shows a discovery message.

FIG. 2c shows a discovery message comprising control information.

FIG. 3a is a signaling diagram illustrating the proposed technique.

FIG. 3b is a flowchart illustrating method steps performed by a transmitting wireless terminal according to some of the example embodiments.

FIGS. 4a to 4c are flowcharts illustrating method steps performed by a receiving wireless terminal according to some of the example embodiments.

FIG. 5 illustrates UE Positioning Architecture applicable to E-UTRAN.

FIGS. 6a and 6b illustrate positioning with D2D link(s).

FIG. 7 illustrates a UE Positioning Architecture with D2D link and UE-NW Relay

FIG. 8 is an example node configuration of transmitting wireless terminal, according to some of the example embodiments.

FIG. 9 is an example node configuration of a receiving wireless terminal, according to some of the example embodiments.

### ABBREVIATIONS

CP cyclic prefix
CRC cyclic redundancy check
D2D device-to-device
D2D ID device-to-device identity
DMRS Demodulation Reference Signal
E-CID enhanced Cell Identity
EPS Evolved Packet System
BER Bit Error Rate
L1 Layer 1
L2 Layer 2
LCS Location Service
MAC Medium Access Control
M2M Machine to Machine
NW Network
OSI Open Systems Interconnection model
PDCP Packet Data Convergence Protocol
PDU Protocol Data Units
PHY Physical Layer
PUSCH Physical Uplink Shared Channel
RLP Radio Link Protocol
RRC Radio Resource Control
SDU service data unit
PRB Physical Resource Block
UL uplink
DL downlink
UE user equipment
UTDOA Uplink-Time Difference of Arrival
3GPP 3rd Generation Partnership Project

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Within the context of this disclosure, the terms “wireless terminal” or “wireless device” encompass any terminal which is able to communicate wirelessly with another device, as well as, optionally, with an access node of a wireless network) by transmitting and/or receiving wireless signals. Thus, the term “wireless terminal” encompasses, but is not limited to: a user equipment, e.g. an LTE UE, a mobile terminal, a stationary or mobile wireless terminal for machine-to-machine communication, an integrated or embedded wireless card, an externally plugged in wireless card, a dongle etc. Throughout this disclosure, the term “user equipment” is sometimes used to exemplify various embodiments. However, this should not be construed as limiting, as the concepts illustrated herein are equally applicable to other wireless terminals. Hence, whenever a “user equipment” or “UE” is referred to in this disclosure, this should be understood as encompassing any wireless terminal as defined above.

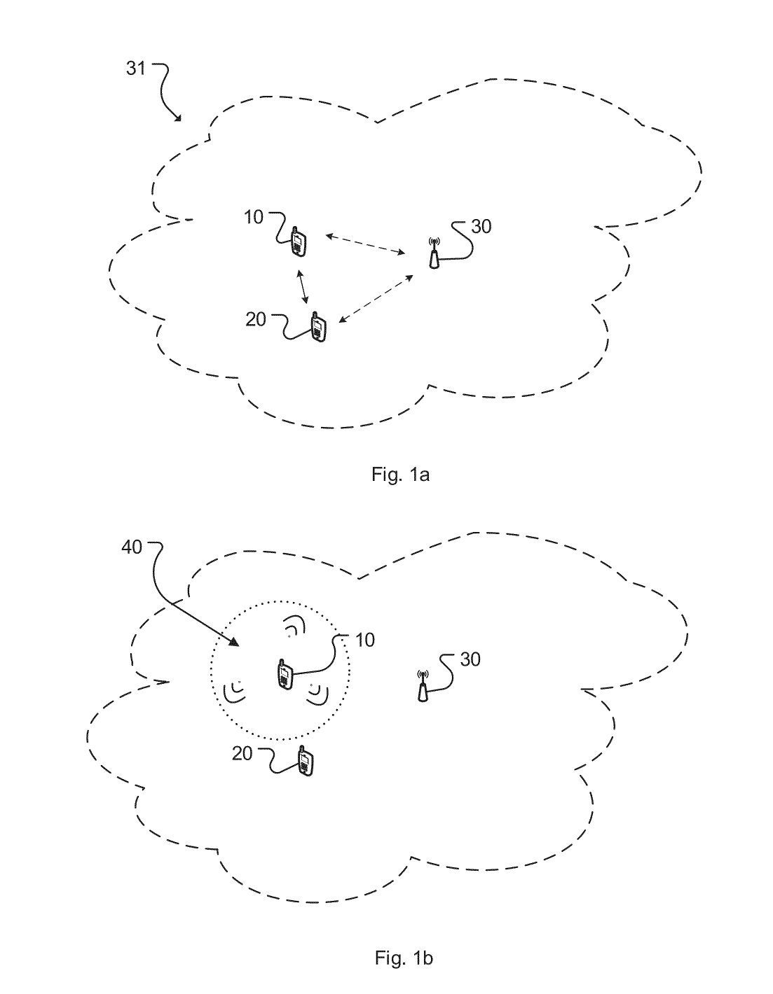

This disclosure relates to device-to-device communication. FIGS. 1a-1b schematically illustrate a mobile communication network including wireless terminals 10 and 20, two UE:s, capable of device-to-device communication. In figure la two UE:s 10, 20 configured for D2D communication exchange information directly, i.e. not over the network. The D2D communication is assisted by a eNodeB 30 defining a cell 31.

FIG. 1b shows a UE 10 broadcasting a discovery message 40 as explained above. In this disclosure a wireless terminal transmitting a discovery message 40 will be referred to as a transmitting wireless terminal 10 and a wireless terminal receiving a discovery message 40 will be referred to as a receiving wireless terminal 20. Note that in real life a terminal will probably be able to be both a receiving and a transmitting wireless terminal.

This disclosure provides a way to distribute control information among D2D devices 10, 20 with small implementation, energy and overhead impact. This is achieved by enriching the D2D discovery message. According to the present standardization the D2D discovery signals comprises identity information of the transmitting device and the identity of an associated application. This information is typically comprised in layer 3. This disclosure proposes including a new type of information in these messages.

In one example, the disclosure consists of including control information in a discovery message or any other broadcast signal transmitted by a wireless terminal, e.g. in order to enable improved range estimation between devices.

In a basic embodiment such information consists of the geographical coordinates of the device. Other embodiments include information about the power setting e.g. transmission power, of the broadcasting device, in order to enable path loss-based range estimation. Additional embodiments include information about the capabilities of the broadcasting device in order to assess its ability to sustain a relay link or other functionalities that require certain capabilities.

Additional use cases include sensing of radio properties around the device and propagating such information to neighbor devices.

For better understanding of the disclosure D2D discovery is first briefly introduced.

D2D Discovery

Devices that want to communicate, or even just discover each other, typically need to transmit various forms of control signaling. One example of such control signaling is the so-called discovery signal, also referred to as discovery signal, discovery beacon or discovery beacon signal, which at least carries some form of identity, referred to as a D2D ID in this disclosure. The information carried by the discovery signal is referred to as a discovery message.

Other devices may scan for the discovery signal. Once they have detected the discovery signal, they can take the appropriate action, for example to try to initiate a connection setup with the device transmitting the discovery message.

A reference discovery payload of approximately 200 bits of discovery information plus 24 bits of CRC may be considered, as an indicative value, according to assumptions in 3GPP.

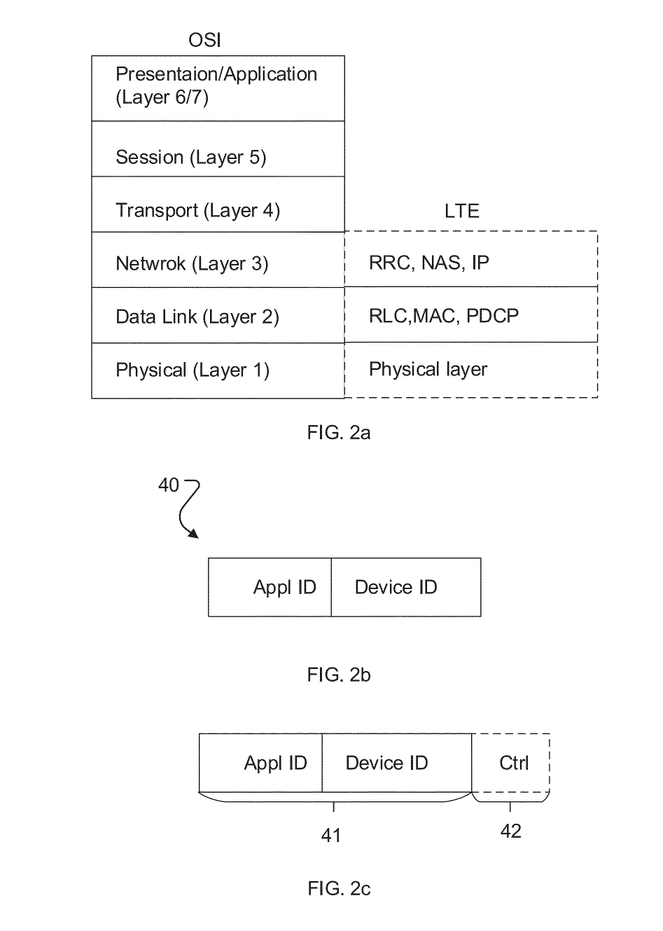

As background information, the Open Systems Interconnection model, OSI, reference model, which is a conceptional model that characterizes and standardizes the internal functions of a communication system by partitioning it into abstraction layers, will be briefly discussed. The OSI model can be seen at the left side of FIG. 2a.

At each level N, two entities e.g. two wireless terminals (peers) exchange protocol data units, PDUs, by means of a layer-N protocol. A layer N serves the layer N+1 above it and is served by the layer N−1 below it. The layers on the top are referred to as the higher layers and the layers at the bottom are referred to as the lower layers. Or stated differently when we refer to payload data in a higher layer than N, this refers to data in PDU of layer that is >N.

A service data unit, SDU, is the payload of a PDU, transmitted unchanged to a peer. Hence, the SDU is a unit of data that is passed down from the higher OSI layer to the next-lower layer, and which the lower layer encapsulates into a PDU. Layer N−1 adds a header or footer, or both, to the SDU, composing a PDU of layer N−1. The PDU at a layer N thus becomes the SDU of at layer N−1.

Hence, if information is provided at Layer N, this implies that the information is provided in an encapsulation added at layer N.

In LTE the lower layers are defined as follows (see FIG. 2a).

Layer 1 or Physical Layer, abbreviated PHY, carries all information from the Medium Access Control, MAC, transport channels over the air interface.

According to 3GPP, Layer 2 structure consists of Packet Data Convergence Protocol, PDCP/Radio Link Control, RLC/MAC sub layers. Transport channels are located between physical layer and MAC layer. MAC multiplexes RLC links and manages scheduling and priority handling serving via logical channels.

The control plane is the part of a network that carries signaling traffic and is responsible for routing. Hence all Layer 1 and Layer 2 protocols are part of the control plane. On the control plane, the RRC layer of Layer 3 is immediately above the PDCP layer of Layer 2. The RRC layer is also part of LTE air interface control plane. Hence, the Radio Protocol Stack refers to the layers and sub-layers managed for the radio link, including the physical layer, PDCP/MAC/PHY sub-layers of Layer 2, and RRC sub-layer of Layer 3. One could say that the the Radio Protocol Stack refers to all the protocols that terminate in the eNodeB.

The prior art discovery message encapsulates packets provided by higher layers (e.g., application layer) directly to a transparent MAC without header, and PHY. Therefore, the content of the discovery message is not terminated at L1/2. This implies that no information that is related to the content of the discovery message is recognized at Layer 1 or Layer 2.

The discovery message at Layer 1 is obtained with a physical format similar to Physical Uplink Shared Channel, PUSCH, except for some different assumptions on e.g. transmission timing, synchronization, cyclic prefix, CP, length and puncturing of the last symbol. Blind retransmissions of the discovery messages are supported, possibly with some resource hopping pattern. Furthermore, different resource allocation methods are supported where the devices contend for common shared resources and where the resources are predefined or assigned by a third node e.g., eNB.

The payload of the discovery message is transmitted using a pre-determined transmission format using according to a number of possible distributed and/or centralized resource allocation methods.

Enriched D2D Discovery messages

The inventors have realized that it is possible to reuse the discovery physical channels by adding radio protocol stack information to a discovery message that was before terminated at layer 2 and only used for other purposes namely discovery.

While in the broadest version of this disclosure, the information added to a discovery message may be at any sub-layer or layer of the radio protocol stack including RRC, for simplicity the discussion below uses layer 1/layer 2 as representative embodiments.

The additional information may be provided at Layer 1 or Layer 2, by appending, prepending or interleaving payload data 41 of a discovery message 40 with additional information, here referred to as control element or control information 42. The principle is illustrated in FIGS. 2b and 2c. FIG. 2b illustrates a prior art discovery message 40 wherein the content of the discovery message is not terminated at L1/2.

FIG. 2c illustrates a Layer 2 encapsulation of the discovery message 40. In this example Layer 2 comprises control information 42 comprising information related to one or more property of the wireless terminal transmitting the discovery message. Hence, the content that it is proposed to include at L1/2 is generally different from what is included at higher layers for discovery.

According to some aspects of this disclosure, control information is also or alternatively carried by an RRC protocol, which is also a sub-layer of radio protocol stack.

In other words it is suggested in this disclosure to reuse an existing physical channel that is already implemented and transmitted to do something else i.e. discovery, to carry information that is used for different purpose(s). Hence, the added information will be available at all layers and no new signals or channels will need to be defined. The added bandwidth is very small.

By adding the information to the discovery massage, the information does not have to be requested, because the discovery message is always transmitted at regular intervals. Furthermore, because no signaling is needed to get the information about device properties, then no delay is added. The device properties are always available right away. No previous contact between the devices is needed.

The device properties may possibly also be used at the physical layer as well e.g. in order to filter out device that are not relevant for D2D communication.

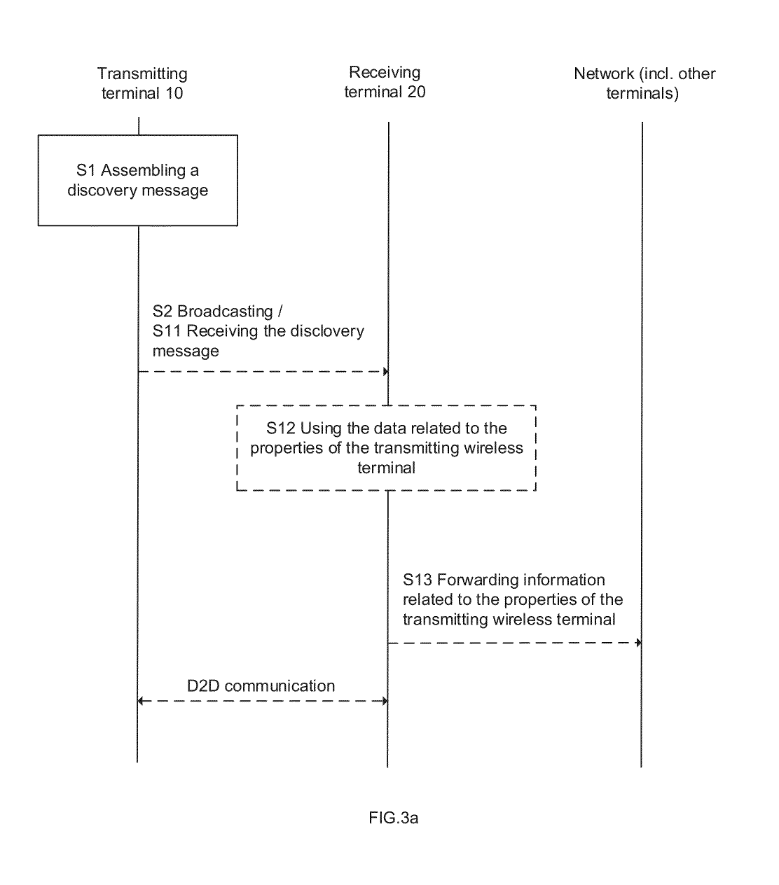

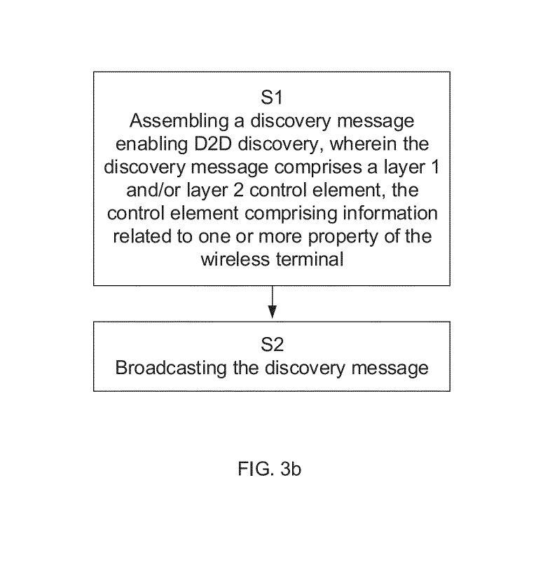

The proposed technique will now be explained referring to FIG. 3a, which illustrates the signaling between two wireless terminals e.g. the wireless terminals 10, 20 in FIGS. 1a or 1b. In other words, the disclosure relates to a wireless communication system comprising two wireless terminals 10, 20. The wireless terminals 10, 20 are configured for device-to-device, D2D, communication.

In accordance with this disclosure, one of the wireless terminals 10 assembles S1 a discovery message 40 enabling D2D discovery. As explained before discovery messages are typically transmitted by D2D devices at regular intervals. According to the proposed technique, the discovery message 40 comprises radio protocol stack control information 42 related to one or more properties of the wireless terminal 10. According to some aspects, the information is defining the physical properties of the wireless terminal such as hardware properties, supported radio access technologies etc. According to some aspects, the information may also define the configuration of the wireless terminal with regards to e.g. M2M configuration. According to another aspect the information defines the experienced conditions at the wireless terminal such as radio conditions.

In the next step, the wireless terminal broadcasts S2 the discovery message. Hence, information about the wireless terminal now becomes available in the communication system. It is not necessary that all discovery messages transmitted by a wireless terminal comprises the control information. The control information may be static or dynamic and e.g. varies based on device configuration or state or is alternatively controlled by the network. The content and the format may be standardized.

The other wireless terminal 20, which will be referred to as the receiving wireless terminal 20, then receives S11 the discovery message.

The receiving wireless terminal 20 may then use S12 the data related to the properties of the transmitting wireless terminal 10 when communicating with one or more other devices in the wireless communication system. For example if the control information relates to the radio properties of the transmitting device, then the receiver may be adopted to optimize reception. The receiving device may also request the transmitting device to change some transmission properties. The information may also be forwarded to higher layers. By providing the data at lower layers it is available for a whole range of applications and functions of different kinds.

Alternatively the receiving wireless terminal 20 forwards S13 data related to the properties of the transmitting wireless terminal 10. According to some aspects, the received data is forwarded as such. Alternatively the receiving device analyses the properties and forwards the result. One example is that the position of the receiving terminal is estimated using the received control information and then data defining the position is forwarded.

The data related to the properties of the transmitting wireless terminal 10 is forwarded in the communication system, which implies that it may be forwarded to an access point and further to a core network and to the internet. The data related to the properties of the transmitting wireless terminal 10 is alternatively forwarded to other terminals, e.g. D2D terminals, in the communication network, either directly or via e.g. an access point.

Example Operations

The proposed methods performed in a wireless terminal transmitting a discovery message will now be presented referring to FIG. 3b illustrating method steps performed by a wireless terminal transmitting a discovery message, according to some of the example embodiments.

Stated differently, this disclosure proposes a method performed in a wireless terminal 10, being configured for device-to-device, D2D, communication in a communication system. The method comprises assembling 51 a discovery message 40 enabling D2D discovery. However, the idea is to reuse this message for other purposes that for discovery.

The discovery message comprises radio protocol stack control information 42. The control information 42 comprises information related to one or more property of the wireless terminal 10 transmitting the discovery message. As described above, the discovery message typically also comprises payload data 41 in higher layer than the control information 42.

Hence, according to this proposal additional information may be provided at L1 by appending, prepending or interleaving the L1 discovery message payload bits with additional information. The mapping is performed according to rules that are known by both the transmitter and receiver, in such a way that a receiver is able to terminate the additional information at L1 and forward the discovery payload to higher layers. The transmission format may be adapted depending on the length of the additional information. The additional information may be inserted before or after channel coding (from transmitter perspective). If it is inserted after channel coding, different channel encoders may be potentially used for the additional information and the discovery message.

Information may also be provided at L2 by appending, prepending or interleaving the L2 discovery message payload bits with additional information, which may be included e.g. in a MAC information element (IE). Hence, according to some aspects, the control information is comprised in a MAC control element. Alternatively, the control information 42 is comprised in a header of the discovery message.

According to some aspects of this disclosure, control information is carried by an RRC protocol, which is also a sub-layer of radio protocol stack.

The mapping of the control information is performed according to rules that are known by both the transmitter and receiver, in such a way that a receiver is able to terminate the additional information at L2 and forward the discovery payload to higher layers. The transmission format may be adapted depending on the length of the additional information. Possibly, padding may also be used to harmonize the payload lengths in case of presence, absence and in case of different lengths of the additional information bits.

The method further comprises the step of broadcasting S2 the discovery message. In other words, the physical channel of the discovery message is reused to do something else than discovery, i.e. to broadcast device properties.

Hence, it is proposed to transmit a broadcast discovery message from D2D, devices carrying radio protocol stack information e.g. Layer 1 or Layer 2 control information comprising at least any combination of any subset of the following information:
Position related information. This may consist of coordinates or similar information obtained with any positioning method available in the device. In a further example this includes information about the method used for obtaining position-related information.
A cell identity or synchronization identity. This may be referred to the cell (if any) that the broadcasting device is transmitting on.
Information about the hardware and/or software capabilities of the device. In one example this includes the capability of directly or indirectly accessing a network infrastructure. In some examples this includes the capability of relaying data (at Layer 1, Layer 2, Layer 3 or other protocol layer in the Open Systems Interconnection model, OSI, reference model) towards another device and/or network. In another example this includes radio bandwidth and/or throughput limitations in the device.
Information about the identities of devices and/or nodes that are reachable and/or in radio proximity of the broadcasting device.
Information about the transmission modes supported by the device on certain radio interface. E.g., for the D2D interface different transmission modes (mode-1, mode-2, mode-3, etc.) may be supported.
Information about the resources to be used for establishing a control or data connection with the broadcasting device, using, e.g., some control or data channel. Such information may point to random access and/or paging resources and associated transmission/reception parameters. Information may include bandwidth, periodicity, time offsets, resource patterns, etc.
Information about the transmission power used by a device for transmitting broadcast signals. Such power may be determined by any power control method used by such device. Information about the transmission power may be used by a receiver for estimating the path loss between the transmitting and receiver devices.
Information about the transmission configuration, antenna directivity/gain, transmission scheme, MIMO scheme or any other parameter affecting the received power for the broadcasted signal. Such information may be used by a receiver when estimating the path loss between the transmitter and receiver devices, e.g., for range estimation.
Information about the maximum supported power, the power headroom (with respect to the maximum available power when transmitting the broadcast signal), MIMO capabilities or any other aspect that may be used by a receiver to infer the potential quality of a radio connection with the device.
Information about the usage of the spectrum or in general of the radio resources in proximity of the device transmitting the message. Such information may consist of the indication of radio resources (time, frequency, space, etc.) which are used or occupied according to some usage criterion, or as an alternative the radio resources (time, frequency, space, etc.) which are free or lightly loaded according to some usage criterion. The objective is to spread information about the usage of radio resources to allow applications such as cognitive radio.

In order to allow the receiver to correctly interpret the content of the broadcast message, different transmission parameters and/or contents may be used to signal the type of contents of the broadcast message. E.g., different Layer 1 parameters (frequency, time resources, reference signal sequences, scrambling initialization sequences, CRC scrambling sequence, radio resource pools, etc.) may be associated to different contents based on some configurable or pre-defined mapping that is known both at the transmitter and receiver. Similarly, some protocol header, e.g., at L1 or L2, may indicate the contents of the message and prevent ambiguities at the receiver.

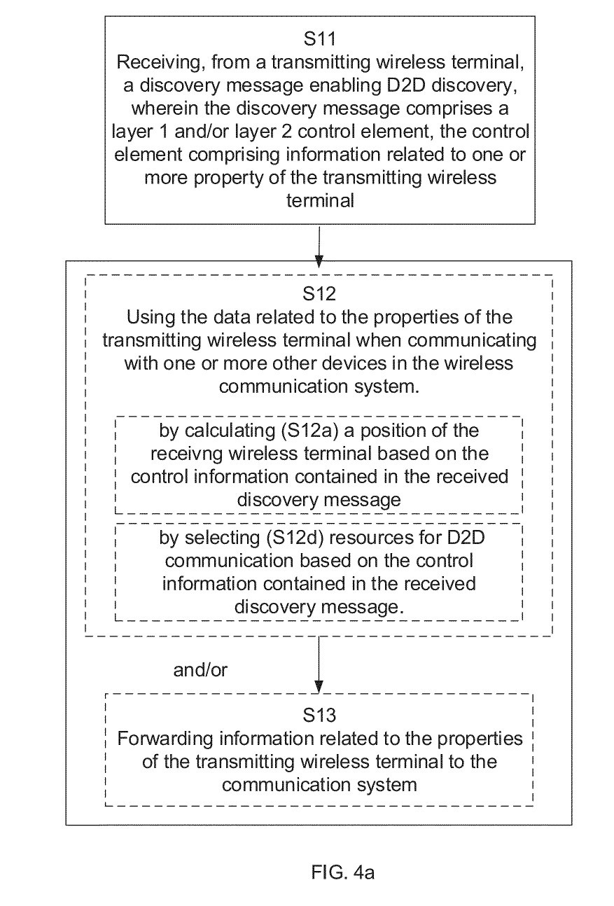

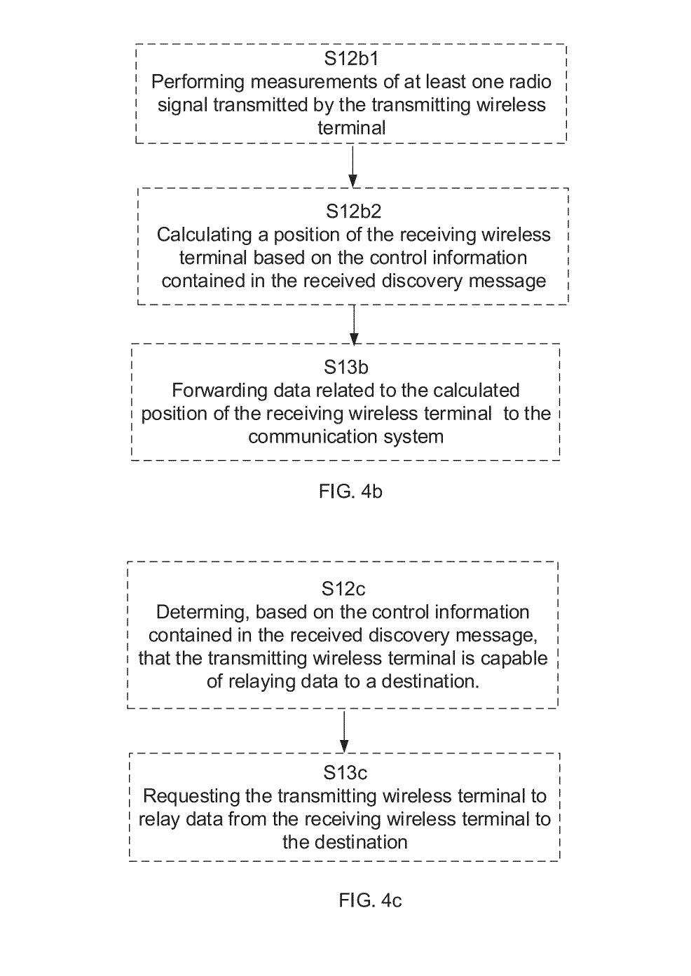

The corresponding methods implemented in a receiving node, here referred to as a receiving wireless terminal 20, will now be described referring to FIG. 4a.

It should be appreciated that FIGS. 4a to 4c comprise some operations which are illustrated with a darker border and some operations which are illustrated with a dashed border. The operations which are comprised in a darker border are operations which are comprised in the broadest example embodiment. The operations which are comprised in a dashed border are example embodiments which may be comprised in, or a part of, or are further operations which may be taken in addition to the operations of the border example embodiments. It should be appreciated that these operations need not be performed in order. Furthermore, it should be appreciated that not all of the operations need to be performed. The example operations may be performed in any order and in any combination.

FIG. 4a shows a method performed in a receiving wireless terminal 20, being configured for device-to-device, D2D, communication in a communication system.

The method comprises receiving, step S11, from a transmitting wireless terminal 10, a discovery message 40 enabling D2D discovery. The discovery message 40 comprises radio protocol stack control information 42 related to one or more properties of the transmitting wireless terminal 10 as described above. As stated above, the mapping of the control information is performed according to rules that are known by both the transmitter and receiver, in such a way that a receiver is able to terminate the additional information at L2 and forward the discovery payload to higher layers.

The received information is then analyzed or used in the receiving wireless terminal 20 in different ways in the receiving wireless terminal, as will be further described below. This is illustrated in steps S12a-S12d explaining different exemplary uses.

The method further comprises the step of using S12 the data related to the properties of the transmitting wireless terminal 10 when communicating with one or more other devices in the wireless communication system and/or forwarding the S13 data related to the properties of the transmitting wireless terminal 10 to another device in the wireless communication system. Using the data related to the properties implies that the receiving wireless terminal 20 extracts information that is e.g. needed in order to improve the radio communication. Such information may relate to the position of the transmitting wireless terminal or to the perceived quality of a radio signal. The information may be sent to higher layers in the wireless terminal and used by higher layers for any purpose.

Forwarding the data implies that the data is used to provide information to the communication system. In one example, data is extracted and sent to an access point e.g. an eNodeB.

In another embodiment, the data in the control information is used to calculate data e.g. a position, which is then forwarded to the communication system. According to some aspects, the forwarding comprises delivering S13 the discovery message 40 to a layer higher than that of the control information 42, in the receiving wireless terminal 20. Then the data may be forwarded e.g. to servers or core network nodes in the communication system.

Different ways of using the information will be described in the following sections.

UE Positioning

According to some aspects, the control information provided in the discovery message is positioning related. Positioning functionality provides a means to determine the geographic position and/or velocity of the UE based on measuring radio signals. The position information may be requested by and reported to a client (e.g., an application) associated with the UE, or by a client within or attached to the core network.

Design of the E-UTRAN positioning capability includes position methods, protocols and procedures. The E-UTRAN may utilize one or more positioning methods in order to determine the position of an UE.

Positioning the UE involves two main steps:
signal measurements; and
position estimate and optional velocity computation based on the measurements.

The signal measurements may be made by the UE or the eNodeB. The basic signals measured for terrestrial position methods are typically the E-UTRA radio transmissions; however, other methods may make use of other transmissions such as general radio navigation signals including those from Global Navigation Satellites Systems (GNSSs).

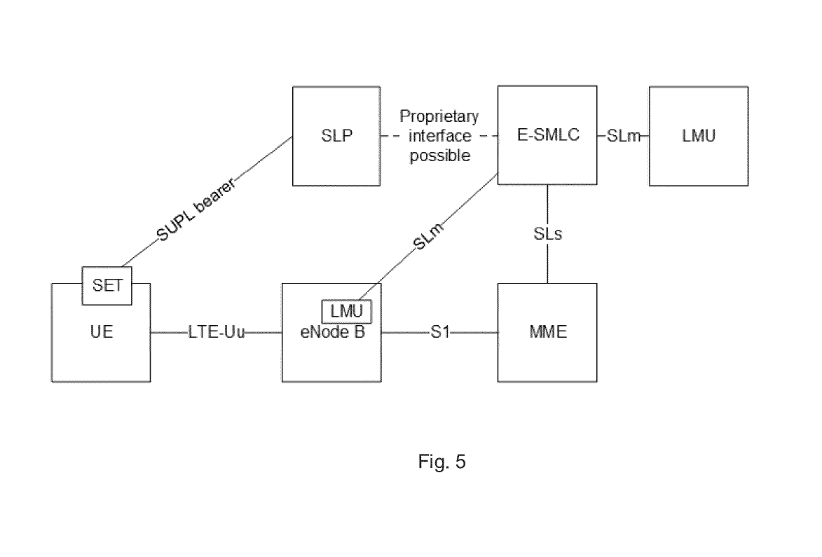

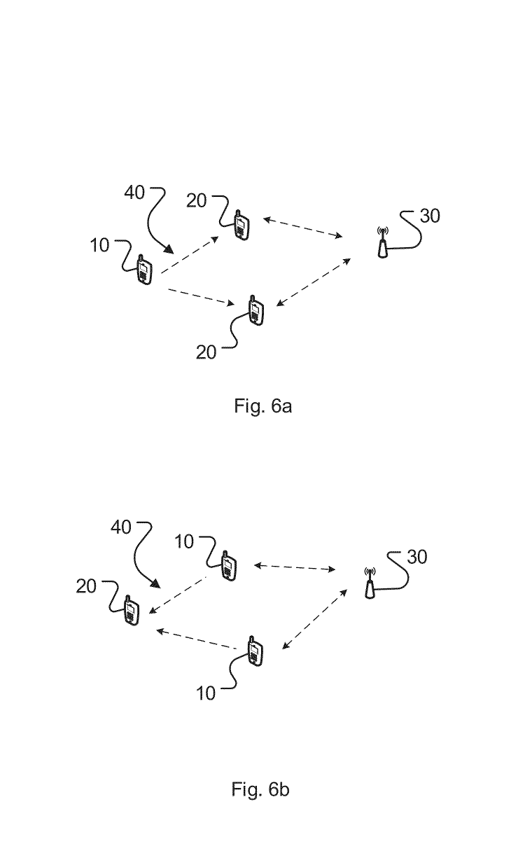

FIG. 5 shows the architecture in the EPS applicable to positioning of a UE with E-UTRAN selected by 3GPP in Release 9.

The location service architecture specified for LTE consists of the evolved SMLC, E-SMLC, connected to the MME over the new SLs interface.

The E-SMLC communicates with the UE for location services and assistance data delivery using the new LPP protocol. It communicates with the eNB for assistance data using the LPP.

According to some aspects of this disclosure, the D2D discovery messages are enriched with positioning related control information 42. The positioning related control information is either information defining a position of the transmitting wireless terminal 10 or information that can be used to derive a position of the transmitting wireless terminal 10. Examples of such information are e.g. coordinates of the device transmitting the discovery message, an indication about transmission power and measurements made by the device transmitting the discovery message. For example if the control information 42 comprises information about transmission power, this measure may, in combination with information about received power, be used for determining a position of the target.

The following sections will describe different use cases where such information is used for enhanced positioning. In the D2D setup, the device to be located is denoted as the target device and the device assisting with the location function is denoted as the reference device. The reference device can be either a regular peer device, or a UE-to-NW relay.

Signal Sent by Target Device

The enriched discovery messages sent for location purpose can be sent by the target device. Hence, the transmitting wireless terminal 10 of FIGS. 1 and 3, may be the target device. According to this aspect, the discovery message includes information such as e.g. the transmission power information of the target device, the antenna directivity and/or antenna gain of the target device, discovery message, etc. The target device sends out the signal, the reception and measurement of the signal is performed by the reference device. The network calculates the target device's location using the information and the measurements.
In one method, the target device sends out its identity, one or more reference devices detects the identity of the target device, and sends the detection to the Location Service, LCS, server. This is analogous to the cell-ID based locationing method.
In another method, the target device sends out the discovery message as explained above. The one or more reference device each performs measurement of the discovery signal. The measurement can be timing based or received power signal based. Each reference device reports the measurement results to the network. The network estimate the distance between the target device and the reference device from the reported measurement. The network aggregates reports from multiple reference devices to derive location estimation of the target device. Depending on the type of measurement made, this is analogous to Enhanced Cell Identity, Uplink-Time Difference of Arrival, etc. type of locationing methods. Thereby, the position of the transmitting wireless terminal 10 can be estimated.

Enhanced Cell Identity, also referred to as E-CID, uses a combination of angular information (the cell sector receiving the signal) and timing information to approximate the location of the handset. Similar to Cell Identification, E-CID fixes the location of the user by identifying which cell in a network is carrying the user's call and translates that information into latitude and longitude. Best used in less dense spaces, E-CID is little more accurate than Cell ID but has the capability of extending to less serviced rural areas.

U-TDOA, or Uplink-Time Difference of Arrival, is a wireless location technology that relies on sensitive receivers typically located at the cell towers to determine the location of a mobile phone

The LCS server estimates the location of the target device based on reports from a multitude of reference devices. In some embodiments, the reference devices are UE-to-network relay devices, so that the reference devices are stationary and with location known to the LCS server. In another embodiment, the reference devices are normal devices (i.e., not UE-to-network relay), whose location is likely to change unpredictably.

Note that the signals and methods above can be used together in a hybrid form to improve location service robustness and accuracy level.

Location utilizing messages sent by the target device can be viewed as the extension of network-based positioning.
The measurement performed by the reference devices can be utilized alone to derive location information of the target device. This is especially true if the target device is out-of-coverage of eNB where the eNB is not able to adequately receive signal from the target device.
The measurement performed by the reference devices can be utilized together with those of eNB(s) when the target device is in-coverage of the eNB(s). More accurate location information can be obtained when both eNB(s) and reference device(s) participate in locating the target device.

### Signal Sent by Reference Devices

The enriched discovery messages sent for location purpose can also be sent by the reference devices. Such discovery messages include one or more of the messages described above. Multiple reference devices may send messages for the purpose of locating a target device.

The reference devices send out their identities and their location information, etc. The target device receives the identities of the reference devices, and/or performs measurements of the radio signal sent by the reference devices.

In one example, the target device can then estimate its own location information. This is particularly useful if the target device is out-of-coverage of eNBs. If the target device is in-coverage of eNB(s), the target device can take into account of measurement of both reference device(s) and visible eNB(s) in estimating its location. If programed, the target device can then display such location information to the user interface.

We are now turning back to FIG. 4a. According to some aspects, the method performed in a receiving wireless terminal further comprises calculating S12aa position of the receiving wireless terminal 20 based on the control information 42 contained in the received discovery message 40. Such information may also comprise the position or coordinates of the transmitting wireless terminal. The receiving wireless terminal may receive the position of several neighbor access point and/or D2D devices. Thereby, a position of the receiving wireless terminal may be estimated.

According to some aspects, shown in FIG. 4b, the method performed in a receiving wireless terminal further comprises performing 512b1 measurements of at least one radio signal transmitted by the transmitting wireless terminal 10, and calculating 512b2 a position of the receiving wireless terminal 20 based on the control information 42 contained in the received discovery message 40. Such control information is e.g. transmission power of a transmitted signal. A distance between the transmitter and the receiver may then be estimated based on the received power in relation to the transmission power.

Then, the forwarding 513b comprises forwarding data related to the calculated position of the receiving wireless terminal 20.

According to some aspects, the target device performs the measurements of the radio signal of the reference devices. The target device then sends the measurements to the network via LPP and LPPa protocol. The network is responsible for deriving the location information of the target device. The network can share the derived location information to other devices or application servers that request location information of the target device.

Enhanced Positioning Architecture

With the D2D link(s) to assist with UE positioning, the E-UTRAN positioning architecture is enhanced.

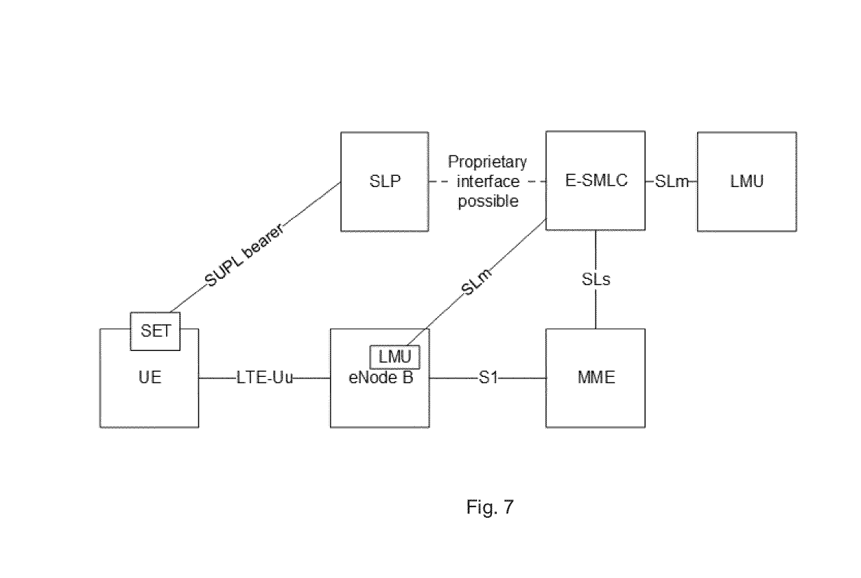

One example is illustrated in FIG. 7, where the addition of the D2D link is illustrated with the UE-NW relay, where the link between the target UE and the UE-NW Relay is the PC5-U interface (which is a D2D link at the physical layer), and the UE-NW Relay to eNB interface is the LTE-Uu. The UE to eNB interface LTE-Uu may or may not exist, depending on if the UE is in-coverage or out-of-coverage of the eNB. Also the UE and eNB may or may or utilizes the radio signal between them for positioning, in addition to the D2D link.

In another example, the UE-NW Relay does not exist between the target UE and eNB. Rather a regular peer UE exist between the target UE and the eNB.

For the purpose of supporting UE-terminated LPP protocol, the protocol stacks of the D2D link provides lower layer functions connecting the target UE and the LCS server, and is transparent to the LPP. The D2D link additionally provides positioning information via the radio signals and/or UE identities transmitted over the D2D link.

For the purpose of supporting eNodeB-terminated LPPa protocol, the protocol is still between eNodeB and the server. The D2D link(s) serve the function of providing positioning information via the radio signals and/or UE identities transmitted over the D2D link.

For the purpose of supporting SUPL protocol for positioning over the user plane, the protocol stacks of the D2D link provides lower layer functions connecting the target UE and the server, and is transparent to the protocol.

M2M

According to some aspects, the D2D discovery messages are enriched with M2M related information. Hence, according to some aspects, the radio protocol stack information added to the discovery messages is M2M related.

In case of M2M (machine to machine), referred to as somehow called even MTC (machine type communication) in 3GPP standards, devices may need to exchange their radio capabilities in order to be able to communicate with a suitable format. Such a need may not be restricted to MTC, since in general any device with special requirements or capabilities may need to signal them in order to be able to use them. While in LTE UE capabilities are reported to the eNB in a UE capability transfer procedure (a RRC procedure) exchanged between the eNB and the UE as part of a reconfiguration process once a connection has been established, here we consider exchanging capabilities in a broadcast fashion, without the need to previously establish a connection. This can be convenient in dense networks where many nodes are present and need to communicate seldom. Also the capabilities are broadcast by UEs.

According to some aspects, the step of using S12, implies determining S12c, see FIG. 4c, based on the control information 42 contained in the received discovery message 40, that the transmitting wireless terminal 10 is capable of relaying data to a destination and requesting S13c the transmitting wireless terminal 10 to relay data from the receiving wireless terminal 20 to the destination. Hence, the receiving wireless terminal forwards information related to the properties of the transmitting wireless terminal to the communication system, by sending S13c a request to relay data from the receiving wireless terminal.

Hence, devices may advertise some special capabilities that may be of interest for multiple receivers in proximity. In one example, a device with UE-to-network relay capability may advertise, such as their capability to provide relayed connection in between another device and the to a network infrastructure. In another example, a device with the capability to communicate with out of NW-infrastructure-coverage devices may broadcast.

Spectrum

According to some aspects, the D2D discovery messages are enriched with spectrum related information. Hence, according to some aspects, the radio protocol stack information added to the discovery messages is spectrum related. According to some aspects, the method in a receiving wireless terminal further comprises the step of selecting S12d, see FIG. 4a, resources for D2D communication in the frequency domain, based on the control information 42 contained in the received discovery message 40. The usage may either be the usage of the spectrum in vicinity of the transmitting wireless terminal, or a general estimation.

In a further use case a device may broadcast information that is not a hardware/software property of itself, rather a property of its radio environment that the device is able to utilize. This includes property of system deployed over licensed spectrum (carrier frequency, bandwidth, duplex), property of the usable unlicensed spectrum (carrier frequency, bandwidth, duty cycle, etc.), the type of network deployed (LTE, WCDMA, etc.). Such broadcast information assists with the establishment and configuration of the D2D link.

In some embodiments, a devices senses properties of the spectrum in its proximity and spreads such information to the devices in proximity. Information about the spectrum may include energy or signals detection for different time, frequency and spatial resources in the spectrum. Ideally, multiple devices would be able to define a map of the spectrum use in time, frequency and space dimensions and they would thus be able to perform advanced applications such as distributed opportunistic spectrum usage with controlled interference generation.

Example Node Configurations

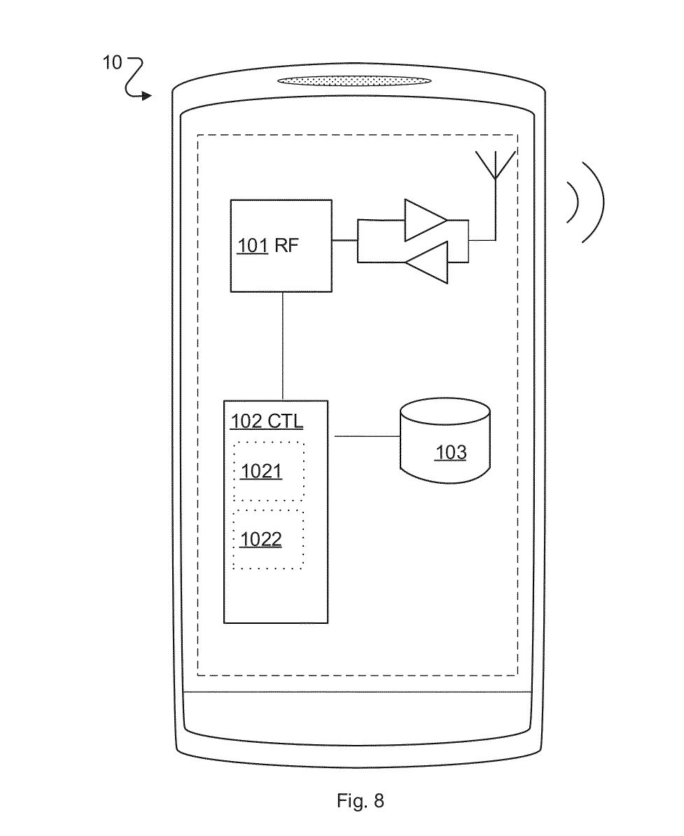

FIG. 8 illustrates an example of a transmitting wireless terminal 10 which may incorporate some of the example embodiments discussed above. As shown in FIG. 8, the transmitting wireless terminal 10 may comprise a radio circuitry or transmit circuitry 101 configured to transmit (and possibly also receive) any form of communications or control signals within a network. It should be appreciated that the radio circuitry 101 may be comprised as any number of transceiving, receiving, and/or transmitting units or circuitry. It should further be appreciated that the radio circuitry 101 may be in the form of any input/output communications port known in the art. The radio circuitry 101 may comprise RF circuitry and baseband processing circuitry (not shown).

The transmitting wireless terminal 10 may further comprise at least one memory unit or circuitry 103 that may be in communication with the radio circuitry 101. The memory 103 may be configured to store received or transmitted data and/or executable program instructions. The memory 103 may also be configured to store any form of beam-forming information, reference signals, and/or feedback data or information. The memory 103 may be any suitable type of computer readable memory and may be of volatile and/or non-volatile type.

The transmitting wireless terminal 10 may further comprise further processing circuitry 102 which may be configured to perform measurements are set configurations provided by the eNodeB. The processing circuitry 102 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry.

The processing circuitry 102 is configured to cause the transmitting wireless terminal 10 to assemble a discovery message 40 enabling D2D discovery, wherein the discovery message 40 comprises radio protocol stack control information 42 related to one or more properties of the transmitting wireless terminal 10 as described above. According to some aspects, the processing circuitry 102 comprises an assembling module for assembling the discovery message.

The transmit circuitry 101 is adapted to broadcast S2 the discovery message 40. The transmitting wireless terminal 10 is further configured to implement all the aspects of the technique discussed in relation to the transmitting wireless terminal 10 above and below.

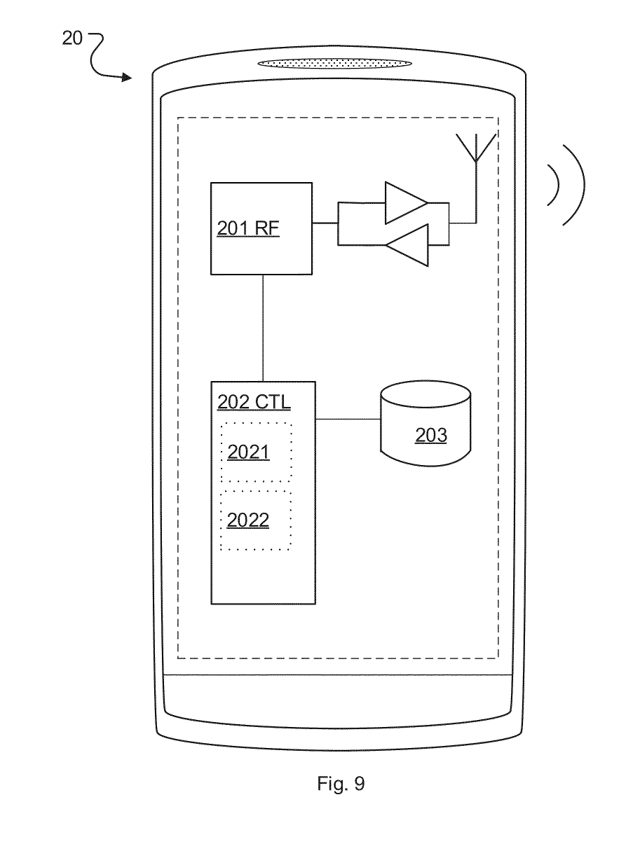

FIG. 9 illustrates an example of a receiving wireless terminal 20 which may incorporate some of the example embodiments discussed above. As shown in FIG. 8, the receiving wireless terminal 20 may comprise a radio circuitry 201 configured to receive and transmit any form of communications or control signals within a network. It should be appreciated that the radio circuitry 201 may be comprised as any number of transceiving, receiving, and/or transmitting units or circuitry. It should further be appreciated that the radio circuitry 201 may be in the form of any input/output communications port known in the art. The radio circuitry 201 may comprise RF circuitry and baseband processing circuitry (not shown).

The receiving wireless terminal 20 may further comprise at least one memory unit or circuitry 203 that may be in communication with the radio circuitry 201. The memory 203 may be configured to store received or transmitted data and/or executable program instructions. The memory 203 may also be configured to store any form of beam-forming information, reference signals, and/or feedback data or information. The memory 203 may be any suitable type of computer readable memory and may be of volatile and/or non-volatile type.

The receiving wireless terminal 20 may further comprise further processing circuitry 202 which may be configured to perform measurements are set configurations provided by the eNodeB. The processing circuitry 202 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry.

The processing circuitry 202 is configured to cause the receiving wireless terminal 20 to receive, using the radio circuitry 201, from a transmitting wireless terminal 10, a discovery message 40 enabling D2D discovery, wherein the discovery message 40 comprises radio protocol stack control information 42 related to one or more properties of the transmitting wireless terminal 10 and to forward, using the radio circuitry 201, data related to the properties of the transmitting wireless terminal 10 to the communication system. According to some aspects, the processing circuitry 202 comprises an receiver module 2021 module for receiving the discovery message. According to some aspects, the processing circuitry 202 comprises a forwarding module 2022 module for forwarding the discovery message.

The receiving wireless terminal 20 is further configured to implement all the aspects of the technique discussed in relation to the receiving wireless terminal above and below.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that although terminology from 3GPP LTE has been used herein to explain the example embodiments, this should not be seen as limiting the scope of the example embodiments to only the aforementioned system. Other wireless systems, including WCDMA, WiMax, UMB and GSM, may also benefit from the example embodiments disclosed herein.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method performed in a receiving wireless terminal (20), the receiving wireless terminal (20) being configured for device-to-device, D2D, communication in a communication system, the method comprising:
receiving (S11), from a transmitting wireless terminal (10), a discovery message (40) enabling D2D discovery, wherein the discovery message (40) comprises radio protocol stack control information (42) related to one or more properties of the transmitting wireless terminal (10); and
forwarding (S13) data related to the properties of the transmitting wireless terminal (10) to another device in the wireless communication system and/or using (S12) the data related to the properties of the transmitting wireless terminal (10) in the receiving wireless terminal (20) when communicating with one or more other devices in the wireless communication system.

2. The method according to claim 1, wherein the forwarding comprises delivering (S13) the discovery message (40) to a layer higher than that of the control information (42), in the receiving wireless terminal (20).

3. The method according to any preceding claim, wherein the discovery message (40) comprises payload data (41) from a layer higher than that of the control information (42).

4. The method according to any preceding claim, further comprising:
calculating (S12a) a position of the receiving wireless terminal (20) based on the control information (42) contained in the received discovery message (40);
wherein the forwarding (S13a) comprises forwarding data related to the calculated position of the receiving wireless terminal (20).

5. The method according to any preceding claim, further comprising:
performing (S12b1) measurements of at least one radio signal transmitted by the transmitting wireless terminal (10), and
calculating (S12b2) a position of the receiving wireless terminal (20) based on the measurements and control information (42) contained in the received discovery message (40);
wherein the forwarding (S13b) comprises forwarding data related to the calculated position of the receiving wireless terminal (20).

6. The method according to any preceding claim, further comprising:
determining (S12c), based on the control information (42) contained in the received discovery message (40), that the transmitting wireless terminal (10) is capable of relaying data to a destination;
requesting (S13c) the transmitting wireless terminal (10) to relay data from the receiving wireless terminal (20) to the destination.

7. The method according to any preceding claim, further comprising:
selecting (S13d) resources for D2D communication in the frequency domain, based on the control information (42) contained in the received discovery message (40);

8. A method performed in a wireless terminal (10), the wireless terminal (10) being configured for device-to-device, D2D, communication in a wireless communication system, the method comprising:
assembling (S1) a discovery message (40) enabling D2D discovery, wherein the discovery message (40) comprises radio protocol stack control information (42) related to one or more properties of the wireless terminal
broadcasting (S2) the discovery message (40).

9. The method according to claim 8, wherein the discovery message (40) comprises payload data (41) from a layer higher than that of the control information (42).

10. The method according to preceding claim 8-9, wherein the control information (42) is positioning related.

11. The method according to claim 10, wherein the positioning related control information (42) is either information defining a position of the wireless terminal (10) or information that can be used to derive a position of the wireless terminal (10).

12. The method according to preceding claim 8-11, wherein the control information (42) is spectrum related.

13. The method according to claim 12, wherein the control information (42) is related to an estimated usage of the spectrum.

14. The method according to preceding claim 8-11, wherein the control information (42) is defining one or more M2M capability of the wireless terminal (10).

15. The method according to preceding claim 8-14, wherein the payload data (41) comprises at least one identity of the wireless terminal (10).

16. The method according to preceding claim 8-15, wherein the control information (42) is comprised in a MAC control element.

17. The method according to preceding claim 8-16, wherein the control information (42) is comprised in a header of the discovery message (40).

18. A wireless terminal (10) being configured for device-to-device, D2D, communication in a communication system, the wireless terminal (10) comprising:
processing circuitry (102) adapted to assemble a discovery message (40) enabling D2D discovery, wherein the discovery message (40) comprises radio protocol stack control information (42) related to one or more properties of the wireless terminal (10); and
transmit circuitry (101) adapted to broadcast (S2) the discovery message (40).

19. A receiving wireless terminal (20) being configured for device-to-device, D2D, communication in a communication system, the receiving wireless terminal (20) comprising:
radio circuitry (201) and
processing circuitry (202) adapted:
to receive, using the radio circuitry (201), from a transmitting wireless terminal (10), a discovery message (40) enabling D2D discovery, wherein the discovery message (40) comprises radio protocol stack control information (42) related to one or more properties of the transmitting wireless terminal (10); and
to use the data related to the properties of the transmitting wireless terminal (10) when communicating with one or more other devices in the wireless communication system and/or to forward the radio circuitry (201), data related to the properties of the transmitting wireless terminal (10) to the communication system.

20. A wireless terminal according to any of claims 18 to 19, wherein the wireless terminal (10, 20) is a user equipment.

21. A wireless terminal according to any of claims 18 to 19, wherein the wireless terminal (10, 20) is a relay node.

22. A computer program comprising computer program code which, when executed in a wireless terminal, causes the wireless terminal to execute the methods according to any of the claims 1-17.
